(19) United States
(12) Patent Application Publication
(10) Pub. No.: US 2016/0164153 A1
(43) Pub. Date: Jun. 9, 2016

(54) LITHIUM-AIR BATTERY SYSTEM

(71) Applicant: Hyundai Motor Company, Seoul (KR)

(72) Inventors: Dong Hui Kim, Suwon (KR); Dae Gun Jin, Suwon (KR); Jun Ki Rhee, Suwon (KR); Kyoung Han Ryu, Yongin (KR)

(21) Appl. No.: 14/865,871

(22) Filed: Sep. 25, 2015

(30) Foreign Application Priority Data
Dec. 4, 2014 (KR) 10-2014-0172891

(51) Int. Cl. H01M 12/08

(52) U.S. Cl. CPC H01M 12/08

(57) ABSTRACT

A lithium-air battery system having a hermetic structure is provided and eliminates the need to be charged with additional oxygen gas. The system includes a lithium-air battery and an oxygen bombe that stores oxygen gas participating in a lithium-oxygen reaction. A first MFC adjusts a flow rate of oxygen gas supplied from the oxygen bombe to lithium-air battery cells. A blower repeatedly supplies oxygen gas flowing from the first MFC into the lithium-air battery cells. A compressor compresses oxygen generated from the lithium-air battery cells and passes through a second MFC, to a high pressure state to charge the oxygen bombe with the compressed oxygen during a charge operation. The second MFC adjusts a flow rate when oxygen gas generated from the lithium-air battery cells is supplied to the compressor during the charge operation. Additionally, an external power source supplies electric power to the compressor to charge the oxygen bombe.

### CROSS-REFERENCE TO RELATED APPLICATION

This application claims under 35 U.S.C. §119 a the benefit of Korean Patent Application No. 10-2014-0172891 filed on Dec. 4, 2014, the entire contents of which are incorporated herein by reference.

### BACKGROUND

(a) Technical Field

The present disclosure relates to a lithium-air battery system, and more particularly, to a lithium-air battery system having a hermetic structure that eliminates the need be charged with additional oxygen gas.

(b) Background Art

A lithium-air battery essentially includes a negative electrode which may occlude and discharge a lithium ion, a positive electrode which oxidizes/reduces oxygen in air, and an electrolyte interposed between the positive electrode and the negative electrode. The lithium-air battery uses lithium as the negative electrode, and need not store air, which is an active positive polar substance, in the battery. Accordingly, the lithium-air battery has an advantage in that it is possible to implement a high capacity battery. Further, theoretical energy density per unit weight is substantial, that is, 3,500 Wh/kg or greater, and the energy density is approximately ten times as high as that of a lithium ion battery.

However, since the existing lithium-air battery of the related art uses an external storage tank or uses oxygen gas included in air, the existing lithium-air battery is manufactured to have a structure in which the positive electrode is opened. The opened structure may result in a decrease in the lifespan of the battery due to impurities flowing in from the exterior when the existing lithium-air battery is charged with additional oxygen. Further, the existing lithium-air battery maintains a form in which an oxygen bombe is mounted, but it is inconvenient since the existing lithium-air battery is required to be charged with oxygen gas as well as electricity.

The above information disclosed in this section is merely for enhancement of understanding the background of the invention and therefore it may contain information that does not form the prior art that is already known in this country to a person of ordinary skill in the art.

### SUMMARY

The present invention provides a lithium-air battery system having a hermetic structure, which uses a compressor that may be operated by an external power source, thereby resolving inconvenience caused when the lithium-air battery system is charged with additional oxygen gas.

In one aspect, the present invention provides a lithium-air battery system that may include: a lithium-air battery; an oxygen bombe configured to store oxygen gas that participates in a lithium-oxygen reaction; a first mass flow controller (MFC) configured to adjust a flow rate of oxygen gas supplied from the oxygen bombe to lithium-air battery cells; a blower configured to repeatedly supply oxygen gas flowing from the first MFC into the lithium-air battery cells; a compressor configured to compress oxygen generated from the lithium-air battery cells and passes through a second MFC, to a high pressure state to charge the oxygen bombe with the compressed oxygen during a charge operation; wherein the second MFC is configured to adjust a flow rate when oxygen gas generated from the lithium-air battery cells is supplied to the compressor during the charge operation; and an external power source configured to supply electric power to the compressor to charge the oxygen bombe.

In an exemplary embodiment, a bombe pressure sensor, configured to monitor oxygen gas pressure, may be mounted at an inlet of the oxygen bombe. The lithium-air battery system may further include a regulator configured to decrease high pressure of oxygen gas, which flows from the oxygen bombe to the first MFC, to predetermined pressure. In addition, the first MFC may be configured to supply an amount of oxygen gas to the lithium-air battery cells at a level sufficient for an electric current that is currently required for a load, while being operated by the controller.

Further, the lithium-air battery system may further include a first valve opened and closed to allow oxygen gas to flow from the oxygen bombe to a regulator during a discharge reaction, and opened and closed to allow oxygen gas to flow from the compressor to the oxygen bombe during the charge operation. Additionally, the lithium-air battery system may further include a second valve configured to block a flow of oxygen directed toward the second MFC during the discharge reaction to automatically circulate oxygen gas, and permit a flow of oxygen directed toward the second MFC when the oxygen bombe is charged.

Furthermore, the lithium-air battery system may further include a first pressure sensor and a second pressure sensor configured to measure a change in pressure of oxygen at a front end at which oxygen flows to the lithium-air battery cells and a change in pressure of oxygen at a rear end at which oxygen is discharged from the lithium-air battery cells, respectively, and transfer the measurement result to the controller.

Through the aforementioned technical solutions, the present invention provides the effects below.

First, a discharge flow for supplying oxygen gas in the oxygen bombe to the lithium-air battery cells and a charge flow for compressing oxygen, which has completed the reaction in the lithium-air battery, in the oxygen bombe and charging the oxygen bombe with oxygen may be performed in a single system, thereby resolving inconvenience caused since the existing lithium-air battery needs to be separately charged with oxygen using external air.

Second, the discharge operation and the charge operation may be performed using 100% oxygen gas, thereby eliminating a filter and a moisture removing process which was used to charge the existing lithium-air battery using exterior air, and eliminating by-products that flow in with oxygen during the charge operation.

Third, an operation of charging the battery with electricity and an operation of charging the oxygen bombe with oxygen gas are required to be performed separately in the related art even though 100% oxygen gas is used with the bombe, but in the present invention, the oxygen bombe may be charged with oxygen using the compressor that may be operated by the external power source, thereby eliminating inconvenience in that the oxygen bombe needs to be separately charged with oxygen gas.

Fourth, to eliminate inefficiency caused when the compressor is operated using the lithium-air battery as an electric power source, the compressor may be operated using the external power source when the oxygen bombe is charged with oxygen, such that the lithium-air battery may be used more efficiently.

### BRIEF DESCRIPTION OF THE DRAWINGS

The above and other features of the present invention will now be described in detail with reference to exemplary embodiments thereof illustrated in the accompanying drawings which are given hereinbelow by way of illustration only, and thus are not limitative of the present invention, and wherein:

FIG. 1 is a configuration diagram illustrating a configuration of a lithium-air battery system according to an exemplary embodiment of the present invention;

FIG. 2 is a configuration diagram illustrating an operation (of consuming oxygen) when the lithium-air battery system according to an exemplary embodiment the present invention discharges; and

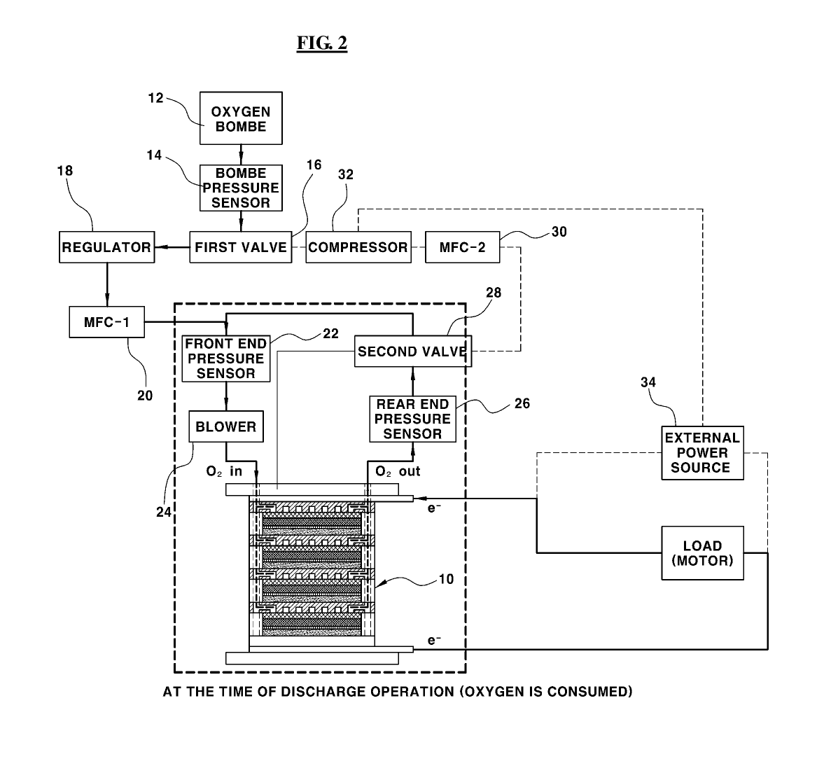

FIG. 3 is a configuration diagram illustrating an operation (of generating oxygen) when the lithium-air battery system according to an exemplary embodiment of the present invention is charged.

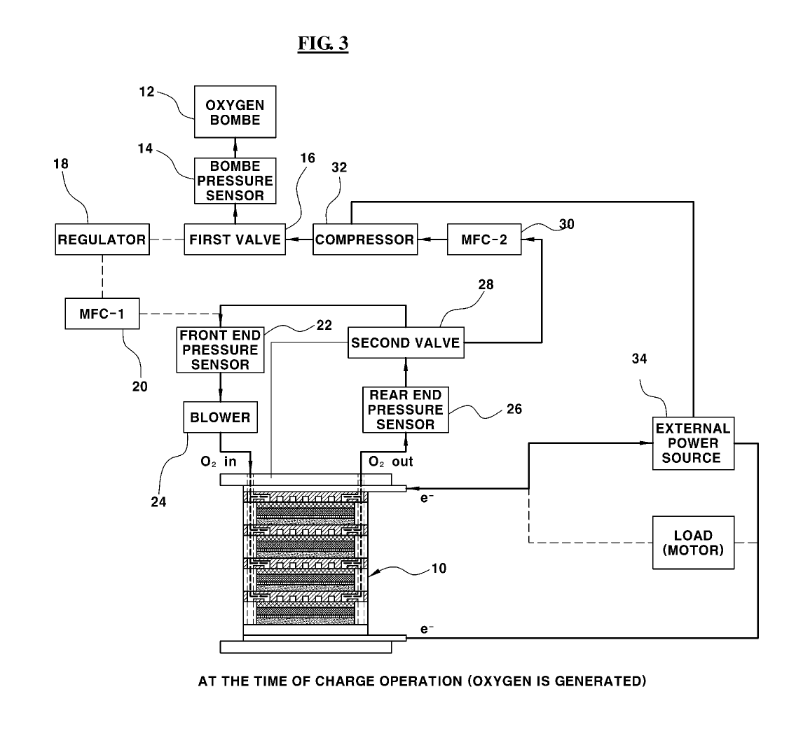

Reference numerals set forth in the Drawings include reference to the following elements as further discussed below:
10: lithium-air battery
12: oxygen bombe
14: bombe pressure sensor
16: first valve
18: regulator
20: first MFC
22: first pressure sensor
24: blower
26: second pressure sensor
28: second valve
30: second MFC
32: compressor
34: external power source

It should be understood that the appended drawings are not necessarily to scale, presenting a somewhat simplified representation of various features illustrative of the basic principles of the invention. The specific design features of the present invention as disclosed herein, including, for example, specific dimensions, orientations, locations, and shapes will be determined in part by the particular intended application and use environment. In the figures, reference numbers refer to the same or equivalent parts of the present invention throughout the several figures of the drawing.

### DETAILED DESCRIPTION

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

Although exemplary embodiment is described as using a plurality of units to perform the exemplary process, it is understood that the exemplary processes may also be performed by one or plurality of modules. Additionally, it is understood that the term controller/control unit refers to a hardware device that includes a memory and a processor. The memory is configured to store the modules and the processor is specifically configured to execute said modules to perform one or more processes which are described further below.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

Hereinafter, reference will now be made in detail to various exemplary embodiments of the present invention, examples of which are illustrated in the accompanying drawings and described below. While the invention will be described in conjunction with exemplary embodiments, it will be understood that the present description is not intended to limit the invention to those exemplary embodiments. On the contrary, the invention is intended to cover not only the exemplary embodiments, but also various alternatives, modifications, equivalents and other embodiments, which may be included within the spirit and scope of the invention as defined by the appended claims.

Hereinafter, an exemplary embodiment of the present invention will be described in detail with reference to the accompanying drawings.

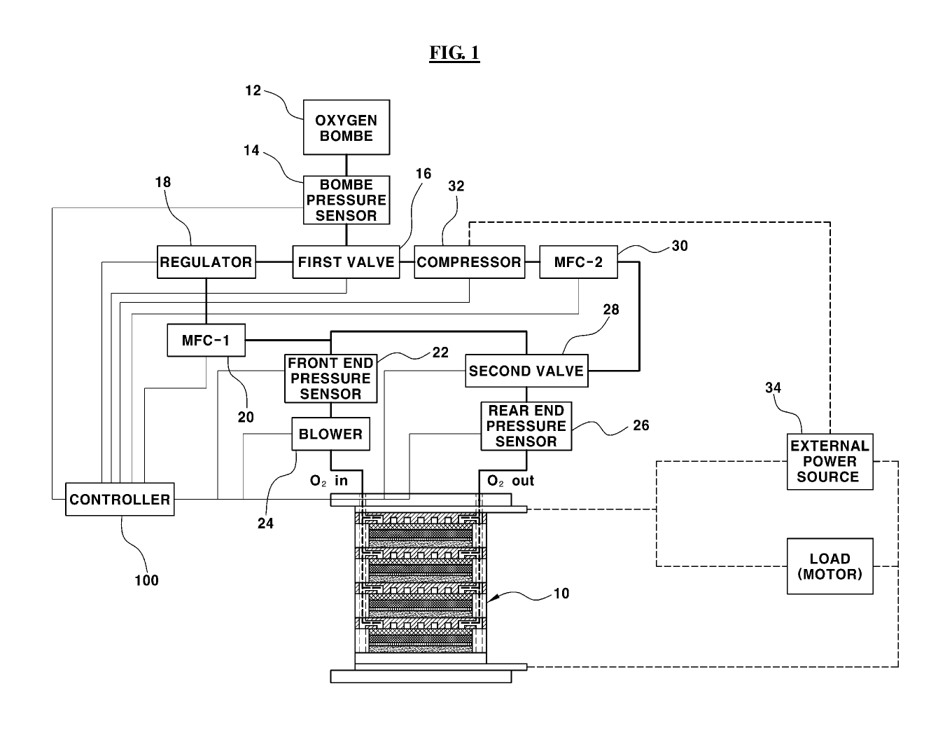

The attached FIG. 1 is a configuration diagram illustrating a configuration of a lithium-air battery system according to an exemplary embodiment of the present invention. In FIG. 1, reference numeral 10 indicates a lithium-air battery that may include a plurality of cells. In particular, the lithium-air battery may include a negative electrode which may be configured to occlude and discharge a lithium ion, a positive electrode may be configured to oxidize/decrease oxygen included in air, and an electrolyte interposed between the positive electrode and the negative electrode.

A device (e.g., a pump or the like) configured to supply oxygen may be connected to the positive electrode of the lithium-air battery. Thus, an oxygen bombe 12, configured to store oxygen gas that participates in a lithium-oxygen reaction, may be connected to the lithium-air battery 10. In particular, a bombe pressure sensor 14, configured to monitor pressure of oxygen gas stored in the oxygen bombe 12, may be mounted at an inlet of the oxygen bombe 12, and a controller 100 may be configured to receive a detected value from the bombe pressure sensor 14. In response to determining that the oxygen pressure is equal to or less than a reference value, the controller may be configured to execute a control logic to provide a warning of this situation.

A first valve 16 may be mounted at an outlet of the oxygen bombe 12. The first valve 16 may be opened to allow oxygen gas in the oxygen bombe 12 to flow toward a regulator 18 when a discharge reaction is performed to supply oxygen in the oxygen bombe 12 to the lithium-air battery 10. Further, the first valve 16 may be opened to allow oxygen compressed by a compressor 32 to flow toward the oxygen bombe 12 when the interior of the oxygen bombe 12 is charged with oxygen. Therefore, the first valve 16 may be a three-way valve, and the regulator 18 and the compressor 32 may be connected to ports of the first valve 16, respectively.

The regulator 18 may be configured to decrease pressure of high-pressure oxygen gas, which flows from the oxygen bombe 12 to a first mass flow controller (MFC) 20, to a predetermined pressure. The first MFC 20 may be configured to supply an amount of oxygen gas to the lithium-air battery cells at a level sufficient for an electric current currently required for a load, while being operated by the controller when oxygen gas of which the pressure has been adjusted by the regulator 18 is supplied to the lithium-air battery cells.

In particular, based on a pressure difference applied to both ends, that is, the inlet and the outlet of the first MFC (pressure is greater at the inlet), the first MFC 20 may be configured to measure and adjust a flow rate of oxygen gas, and to transfer the flow rate to the controller 100. In addition, based on power required for a device load (e.g., a motor), the controller 100 may be configured to calculate a currently required electric current, and transfer the calculated electric current to the first MFC 20 to adjust a flow rate of oxygen gas to supply a required amount of oxygen gas to the lithium-air battery. In addition, a blower 24, configured to repeatedly supply oxygen gas flowing from the first MFC 20 into the lithium-air battery cells, may be mounted between the first MFC 20 and an oxygen inlet of the lithium-air battery 10.

Further, a second valve 28 may be connected to the outlet of the lithium-air battery 10. The second valve 28 may be closed to automatically circulate oxygen gas and block a flow of oxygen directed toward the second MFC 30 when a discharge reaction is performed to supply oxygen in the oxygen bombe 12 to the lithium-air battery 10. The second valve 28 may also be opened to permit a flow of oxygen directed toward the second MFC 30 when the oxygen bombe 12 is charged. The second MFC 30 may be configured to adjust a flow rate of oxygen when oxygen gas generated by the lithium-air battery cells is supplied to the compressor when the oxygen bombe 12 is charged.

According to an exemplary embodiment of the present invention, the compressor 32 may be mounted between the outlet of the second MFC 30 and the first valve 16, such that when the oxygen bombe 12 is charged with oxygen gas generated by the lithium-air battery 10, the compressor 32 may be configured to compress oxygen, generated by the lithium-air battery cells and passes through the second MFC 30, to a high pressure state, and to charge the oxygen bombe 12 with the compressed oxygen. The compressor 32 may be operated by an external power source 34 without using the autonomous lithium-air battery 10, enabling the lithium-air battery 10 to be used more efficiently for a required load.

Meanwhile, a first pressure sensor 22, configured to measure pressure of oxygen flowing toward a front end of the lithium-air battery cells and transfer the measured pressure to the controller 100, may be mounted between the first MFC 20 and the blower 24, and a second pressure sensor 28, configured to measure a change in pressure of discharged oxygen and transfer the measurement result to the controller 100, may be mounted at a rear end of the lithium-air battery cells.

In particular, the controller 100 may be configured to receive signals from the first pressure sensor 22 and the second pressure sensor 28, determine whether it is currently necessary to supply oxygen into the lithium-air battery cells, operate the respective MFCs based on a rate of oxygen gas, consumed during a discharge operation, to increase a flow rate of oxygen, and adjust flow rates of the respective MFCs based on a pressure change due to oxygen gas generated during a charge operation.

In particular, an operation flow of the lithium-air battery system of the present invention, which includes the aforementioned configurations, will be described below.

Discharge Operation

In a state in which an electric current does not flow, that is, when a reaction for producing electrical energy is not performed in the lithium-air battery, oxygen at a predetermined pressure may be included in flow paths, piping, and the like of the lithium-air battery cells. Accordingly, when an external load (e.g., motor) requires an electric current and the lithium-air battery cells perform the discharge reaction, the lithium-air battery cells may produce electrical energy using oxygen gas included in the flow path and piping in the lithium-air battery cells.

Particularly, the first pressure sensor 22 and the second pressure sensor 26 may be configured to measure current pressure in the lithium-air battery cells, and when the pressure decreases to predetermined pressure or less, the controller 100 may be configured to determine the detected value of the bombe pressure sensor 14 mounted at the outlet of the oxygen bombe 12, and determine whether oxygen gas is sufficient in the oxygen bombe 12. When oxygen pressure is sufficient in the oxygen bombe 12, the controller 100 may be configured to operate the second valve 16 to be opened toward the regulator 18 (e.g., the second valve 16 may always be opened toward the regulator during the discharge reaction).

Consecutively, the regulator 18 may be configured to adjust pressure of oxygen passing through the second valve 16 to a predetermined pressure, and decrease high oxygen pressure to predetermined pressure that is suitable to operate the first MFC 20. The first MFC 20 may then be configured to supply oxygen to the lithium-air battery at a flow rate calculated based on an amount of electric current currently used for a load, and oxygen pressure at a front end and a rear end of the lithium-air battery cells.

In particular, when the oxygen pressure at the front end and the rear end of the lithium-air battery cells reaches a predetermined value or greater, the first MFC 20 may be configured to adjust a flow rate of oxygen to be reduced or blocked. For reference, when a flow rate of oxygen exceeds a predetermined level or greater even though the same oxygen pressure is present at air electrodes in the lithium-air battery cells, a uniform electrode reaction may be performed.

Further, the blower 24 may be configured to produce an artificial flow of oxygen gas and supply oxygen gas to the lithium-air battery cells to minimize a local change in pressure due to consumption of oxygen gas at the air electrodes in the lithium-air battery cells, thereby minimizing a pressure difference of oxygen present at or passes through the first pressure sensor, the second pressure sensor, the blower, the respective valves, and the like as well as the interior of the lithium-air battery cells.

Additionally, to uniformly supply oxygen, a rate of the blower may be adjusted based on a pressure difference between the front end and the rear end of the lithium-air battery cells. In particular, the rate of the blower may be adjusted so that pressure at the front end is greater than a predetermined level to consider back pressure caused by air flow paths in the lithium-air battery cells.

As described above, the lithium-air battery may be configured to produce electrical energy required for a load (e.g., motor) using oxygen supplied from the blower 24, and may be configured to provide a warning to a user to recognize oxygen pressure remaining in the oxygen bombe 12 when the discharge operation ends.

Charge Operation

According to a charge operation mode of the present invention, after the reaction in the lithium-air battery cells ends, it may be possible to compress oxygen remaining in the respective flow paths and piping, and to charge the oxygen bombe with oxygen. Accordingly, electric power may be supplied from the external power source 34 to the compressor 32, and the first valve 16 may be operated by the controller 100 to be opened to allow oxygen compressed by the compressor 32 to flow to the oxygen bombe 12, and the second valve 28 may be operated by the controller 100 to be opened to allow oxygen to flow from the lithium-air battery 10 to the second MFC 30.

Accordingly, when the compressor 32 may be operated by the external power source 34, pressure at a front end of the compressor may decrease, and pressure at a rear end of the compressor may increase. Particularly, when the battery is charged by an electric current from the external power source 34, oxygen gas may be generated in the electrodes in the lithium-air battery cells, to increase oxygen pressure.

When oxygen pressure detected by the first and second pressure sensors 22 and 26, connected to the front end and the rear end of the lithium-air battery cells 10, reaches a predetermined pressure or greater, the second valve 28 may be opened toward the second MFC 30 as described above, and the second MFC 30 may be configured to determine a flow rate based on information of the first and second pressure sensors 22 and 26. In other words, the second MFC 30 may be configured to supply oxygen to the compressor 32 while adjusting a flow rate of oxygen to maintain predetermined pressure in the lithium-air battery cells.

Accordingly, the compressor 32 may be configured to compress oxygen to high pressure to charge the oxygen bombe 12 with oxygen. Consecutively, when pressure of the compressor 32 reaches predetermined pressure or greater, the first valve 16 may be opened, as described above, to pass oxygen compressed by the compressor 32 through the first valve 16, and then the oxygen bombe 12 may be charged with oxygen.

Meanwhile, based on pressure of the oxygen bombe 12 and a voltage of the lithium-air battery cells, a point of time at which the charge operation ends may be determined. As described above, unlike the case in the related art in which an operation of charging the battery with electricity and an operation of charging the oxygen bombe with oxygen gas are performed separately, in the present invention, the oxygen bombe may be charged with oxygen using the compressor that may be operated by the external power source, thereby eliminating inconvenience in that the oxygen bombe needs to be separately charged with oxygen gas.

The invention has been described in detail with reference to exemplary embodiments thereof. However, it will be appreciated by those skilled in the art that changes may be made in these exemplary embodiments without departing from the principles and spirit of the invention, the scope of which is defined in the appended claims and their equivalents.

What is claimed is:

1. A lithium-air battery system, comprising:
a lithium-air battery;
an oxygen bombe configured to store oxygen gas that participates in a lithium-oxygen reaction;
a first mass flow controller (MFC) configured to adjust a flow rate of oxygen gas supplied from the oxygen bombe to lithium-air battery cells;
a blower configured to repeatedly supply oxygen gas flowing from the first MFC into the lithium-air battery cells;
a compressor configured to compress oxygen generated from the lithium-air battery cells and passes through a second MFC, to a high pressure state to charge the oxygen bombe with the compressed oxygen during a charge operation, wherein the second MFC is configured to adjust a flow rate when oxygen gas generated from the lithium-air battery cells is supplied to the compressor during the charge operation; and
an external power source configured to supply electric power to the compressor to charge the oxygen bombe.

2. The lithium-air battery system of claim 1, wherein a bombe pressure sensor, configured to monitor oxygen gas pressure, is mounted at an inlet of the oxygen bombe.

3. The lithium-air battery system of claim 1, further comprising:
a regulator configured to reduce high pressure of oxygen gas, which flows from the oxygen bombe to the first MFC, to predetermined pressure.

4. The lithium-air battery system of claim 1, wherein the first MFC is configured to supply an amount of oxygen gas to the lithium-air battery cells at a level sufficient for an electric current currently required for a load, while being operated by a controller.

5. The lithium-air battery system of claim 1, further comprising:
a first valve opened and closed to allow oxygen gas to flow from the oxygen bombe to a regulator during a discharge reaction, and opened and closed to allow oxygen gas to flow from the compressor to the oxygen bombe during the charge operation.

6. The lithium-air battery system of claim 1, further comprising:
a second valve configured to block a flow of oxygen directed toward the second MFC during a discharge reaction to automatically circulate oxygen gas, and permit a flow of oxygen directed toward the second MFC when the oxygen bombe is charged.

7. The lithium-air battery system of claim 1, further comprising:
a first pressure sensor and a second pressure sensor configured to measure a pressure change of oxygen at a front end at which oxygen flows to the lithium-air battery cells and a pressure change of oxygen at a rear end at which oxygen is discharged from the lithium-air battery cells, respectively, and transfer the measurement result to a controller.
